(19) United States
(12) Patent Application Publication
(10) Pub. No.: US 2025/0115457 A1
(43) Pub. Date: Apr. 10, 2025

(54) MEDIA SUPPLY DEVICE

(71) Applicant: PINNACLE FURNITURE LIMITED, Crawley, West Sussex (GB)

(72) Inventors: Daryl STANLEY, Crawley (GB); Kevin QUIGLEY, Longden Coleham (GB); Nicholas LLOYD, Newtown (GB)

(21) Appl. No.: 18/730,909

(22) PCT Filed: Jan. 20, 2023
(86) PCT No.: PCT/EP2023/025026

§ 371 Date: Jul. 22, 2024

(30) Foreign Application Priority Data
Jan. 20, 2022 (GB) 2200738.9

(51) Int. Cl. B65H 75/36; B65H 75/44

(52) U.S. Cl. CPC B65H 75/364; B65H 75/4481; B65H 2701/33; B65H 2701/34

(57) ABSTRACT

Media supply units are described for the provision of media such as electricity, gas, data or compressed air. The units comprise a base unit (1) adapted to be installed in or on a ceiling structure and a media outlet supply head (2) connected to the base unit by means of a flexible support member fixed at its ends to the supply head and to the hub of a spool in the base unit. One or more electrical cables or pipes are also arranged between the hub of the spool and the supply head (2), and the flexible support member is a non-stretch conduit (30) which can be wound on to or from the spool in order respectively to raise or lower the supply head relative to the base unit. When lowered, the supply head (2) may rest on a school desk or table.

This invention relates to media supply units, particularly for use in classrooms for teaching science.

Traditional school teaching laboratories require dedicated fixed installations, often consisting of a series of benches, each of which is provided with supplies of water, gas, electricity and optionally other media, such as data connections or compressed air. Such installations are specifically constructed and the traditional “school laboratory” is ill-suited for any other teaching purpose.

It is known to equip a classroom with media supply units located in the ceiling or as wall-mounted units, which can be deployed when it is desired to incorporate bench work for the pupils into a teaching session and retracted to a stored position when the benches serve as desks or tables at or around which the pupils can be seated and on which they can place books, writing materials and the like.

US 2013/0014985 discloses a system for providing, on a desk or table in an office or conference room, a module providing power and data outlets. The module may be lowered from a stowed position in a ceiling structure on to a table or desk below.

US 2006/0252303 and US 2014/0315423 both disclose systems enabling an electrical power socket to be lowered down from a ceiling fixture on to a table below.

DE 20318044 U1 discloses an arrangement for a classroom where a central ceiling-mounted supply unit is provided with a number of hinged arms, the ends of which remote from the central unit can be lowered to provide media outlets above tables located beneath them.

US 2017/0080429 A1 describes a media supply device for laboratory media which can be deployed to provide media outlets above a work surface such as a table.

EP 2367248 A2 describes a ceiling-mounted system with an arm which can be swung down with media connections at its then lower end. EP 1916749 A2 discloses other ceiling-mounted arrangements, of substantially complex construction, while US 2017/0016572 discloses a ceiling-mounted system with one or more deployable arms for enabling media and data to be supplied.

A disadvantage of the last five of these known systems is that the mechanisms used to deploy the media supply head, for example including electrical and gas outlets, relative to a fixed mounting or base, is mechanically complex and can be damaged if care is not taken when moving the media supply head relative to its base. The complex construction results in additional costs, which has adverse budgetary implications for many schools.

WO2020/109521 discloses a media supply unit including a ceiling-mounted base unit and a media outlet supply head connected to the base unit by means of a flexible support cable and where the support cable is bundled together with at least one electrical cable and at least one media supply pipe, each connected between the base unit and the media outlet supply head, and where the support cable and the electrical cable(s) and pipe(s) can be wound up on to, or unwound from a drum or one or more spools located in the base unit when it is desired to lower or raise respectively the media outlet supply head relative to the base unit. The electrical cable(s) and pipe(s) may be wound on to, or unwound from, a common spool or drum or separate spools.

In accordance with the present invention, an inextensible support cable, the electrical cable(s) and/or media supply pipe(s) which run between the base unit and the media outlet supply head extend from the media supply head towards the base unit within a flexible conduit which is non-stretchable, i.e. essentially inextensible, and which is arranged to be wound on to a spool in the base unit to raise the media supply head or unwound from the spool to lower it. The spool may include a hub to which the upper end of the flexible conduit is attached. The lower end of the flexible conduit is fixed to the supply head.

Because the flexible conduit is essentially inextensible, it takes up the weight of the supply head and the media supply pipes, wires or cables within the flexible conduit itself are not subject to any longitudinal strain. A preferred construction for the flexible conduit is that of an outer tubular flexible casing and, fixed relative to each end of the casing, a flexible wire or rope, for example a multistrand spiral wound steel wire.

The feed of electricity or of a medium such as gas to the hub of the spool is preferably via rotary connectors of known types.

Preferably one side of the spool, usually that below the flexible conduit wound on to it, is in the form of a circular support disc with a toothed edge on which a drive cog is engaged, the drive cog being driven by an electric motor to rotate the disc and unwind the flexible conduit from or wind it up on to the spool respectively to lower or raise the supply head.

The base unit preferably is constructed and arranged so that the axis of rotation of the spool is vertical and guide means are provided to turn the flexible conduit, as it is deployed from the spool, through 90 degrees so that it extends vertically downwards.

The media supply unit preferably includes means in the media outlet supply head to detect when it is resting on a desk or table, for example a baseplate with feet to rest on the desk or table surface and mounted via a lost motion connection to a fixed frame within the supply head and associated with a microswitch actuated when the baseplate and fixed frame move closer together as the supply head comes to rest. Such an arrangement also operates to detect if the supply head encounters an obstruction as it is lowered.

An alternative approach is to control the electric motor which is used to raise or lower the head by way of a motor controller unit which can detect variations in the motor load and, for example, stop lowering the supply head if the motor load suddenly decreases, as would occur when the supply head comes to rest on a table or encounters an obstruction, or suddenly increases as the head comes to rest against a stop when the flexible conduit is fully wound on to the spool.

Means may be provided to enable the supply of media to the media outlet head only when the media outlet supply head is resting on a table or bench. One way of achieving this is to provide, within the ceiling-mounted base unit, or elsewhere in the media supply arrangements, valve and/or switch means which are actuated to cut off the supply of media when the media outlet supply head is lifted from the surface. Alternatively, the supply of media may be centrally controlled for a plurality of media supply units located in the ceiling of a teaching room with a teacher-operated control to switch on the supplies of e.g. gas and/or electricity only after checking that all the units are safely deployed.

The media supply units in accordance with the invention may be easily fitted within a conventional suspended ceiling arrangement, such as is customary in many school or other non-residential buildings, with the base unit firmly secured in place, for example by tie rods to the ceiling structure of the building and where supplies of electricity, gas, compressed air, data or the like can be arranged between the ceiling structure of the building and the suspended ceiling. The supply of electricity may be provided via two or more cables to enable two or more different voltage supplies to be available. It is also possible to arrange for each of a plurality of media supply units to be connected to a central control box, for example mounted on the wall of a classroom, which enables the media outlet supply heads to be deployed when necessary or raised when not required for use, either all together or individually.

One way of putting the present invention into effect is illustrated, by way of example, with reference to the accompanying drawings. These show diagrammatically a media supply unit designed to provide gas and electrical outlets from a supply head which can be raised or lowered by means of a ceiling mounted mechanism, and which is designed to rest on a work table when lowered.

In the drawings:

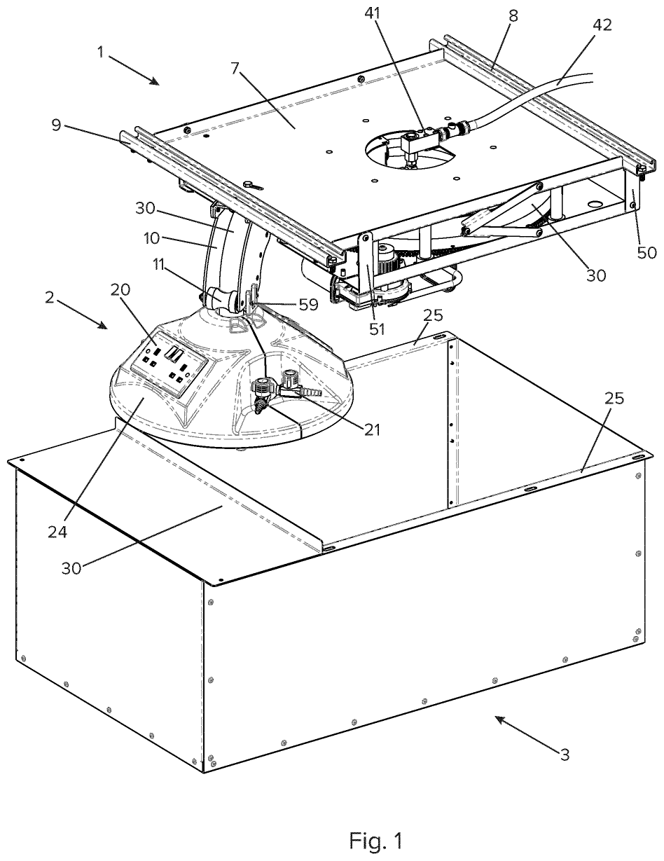

FIG. 1 is a general arrangement view of the media supply unit and the housing in which it is to be located within a ceiling structure;

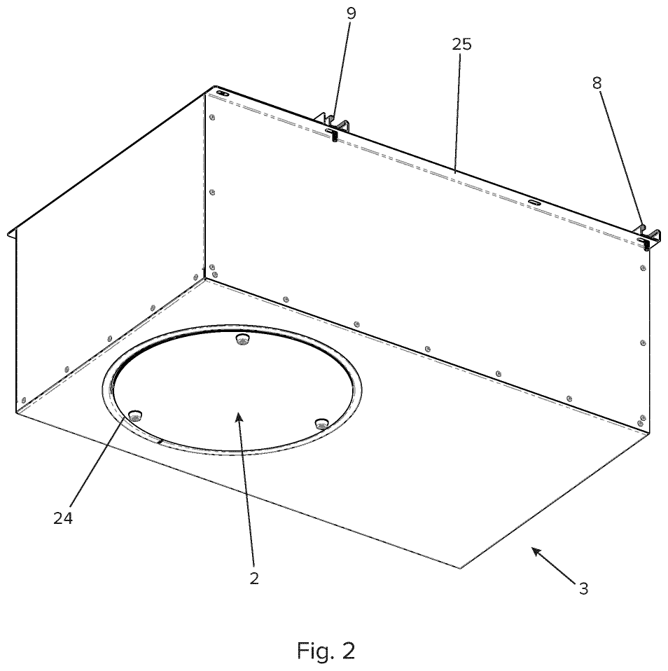

FIG. 2 is a view from below of the unit showing the bottom of the outlets supply head when it lies within the housing;

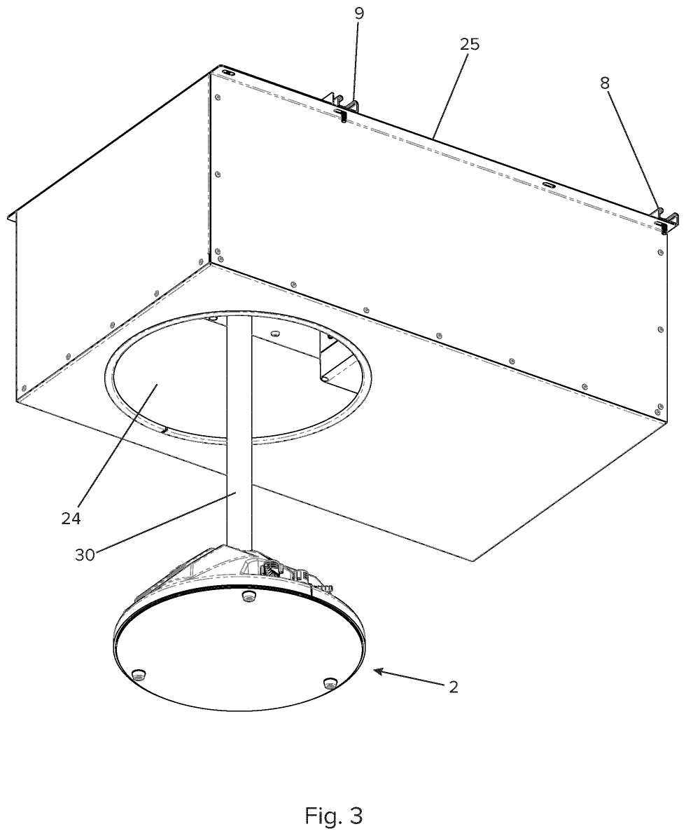

FIG. 3 is a view from below showing the outlets supply head being lowered from the housing;

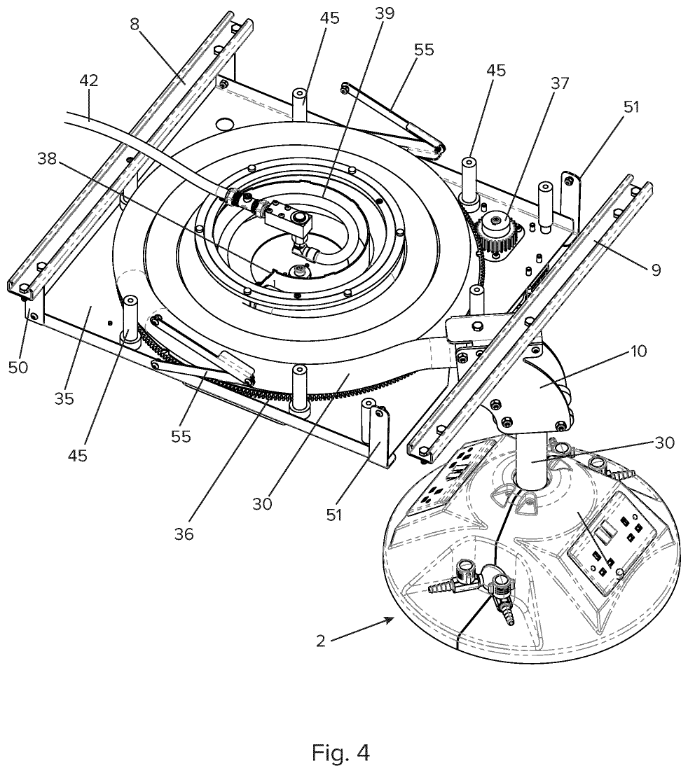

FIG. 4 is a simplified view from above of the principal working components of the unit and showing a supply head during lowering;

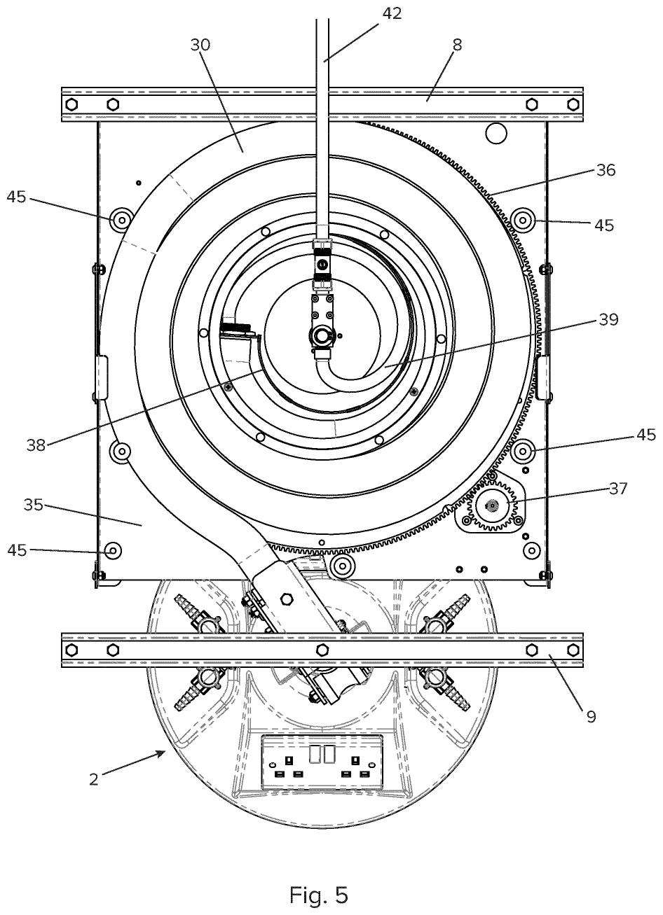

FIG. 5 is a view of the components shown in FIG. 4 but directly from above;

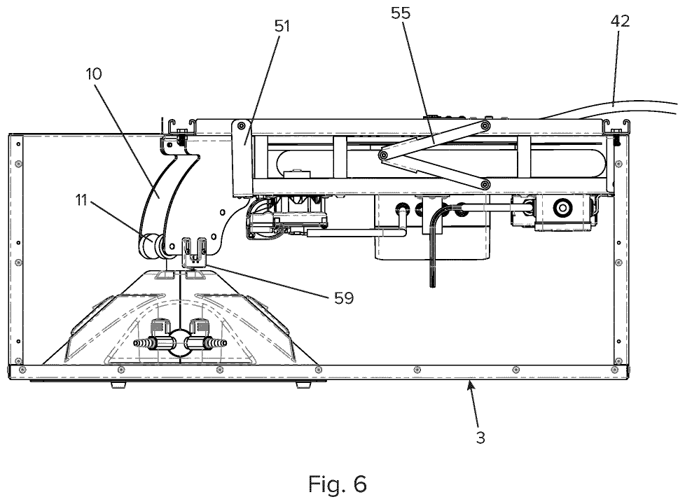

FIG. 6 is a diagram of the ceiling mounted unit with the media supply head retracted and seen from the side;

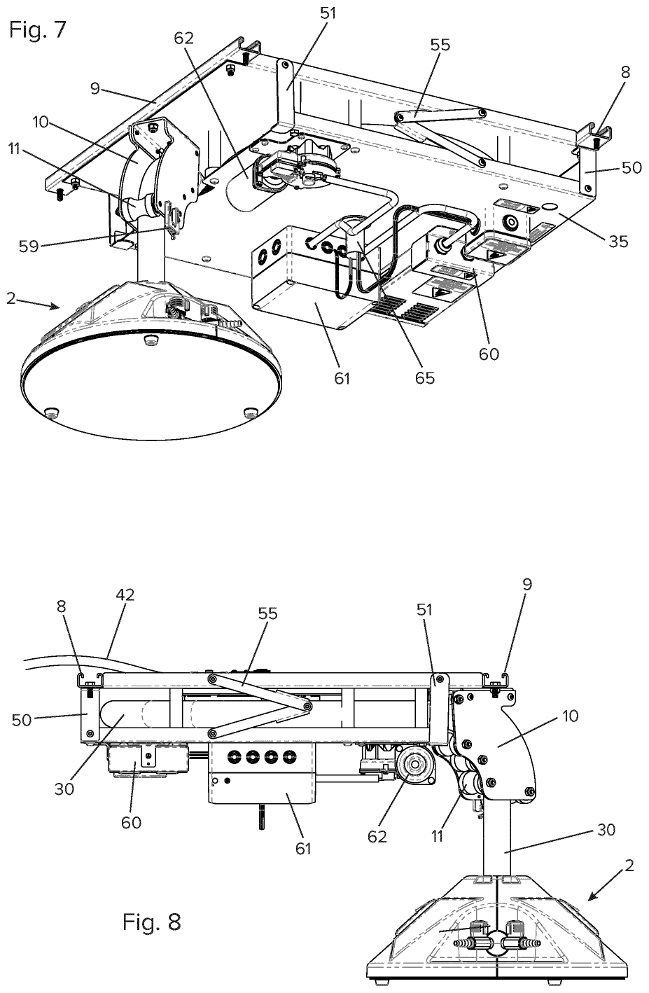

FIG. 7 is an isometric view from below and showing the arrangements of the working components of the unit shortly after lowering of the media supply head has commenced;

FIG. 8 is a side view of the components shown in FIG. 7;

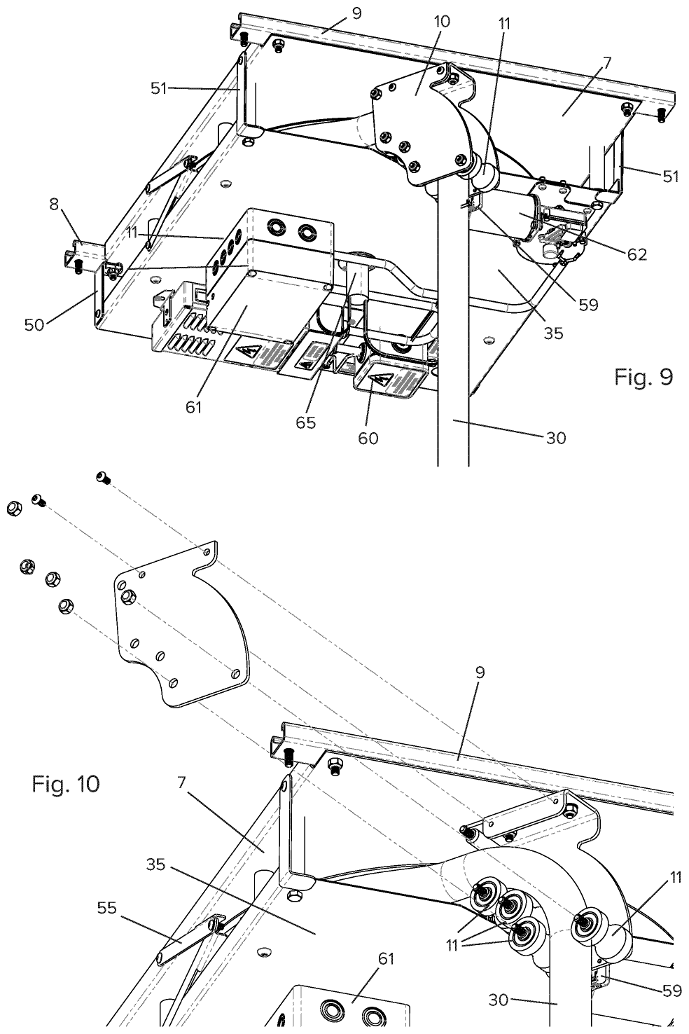

FIG. 9 is an isometric view from below and from the opposite side to that shown in FIG. 7 after the media supply head has been further lowered;

FIG. 10 is an isometric exploded view from below and showing the detail of arrangements for guidance of the flexible conduit;

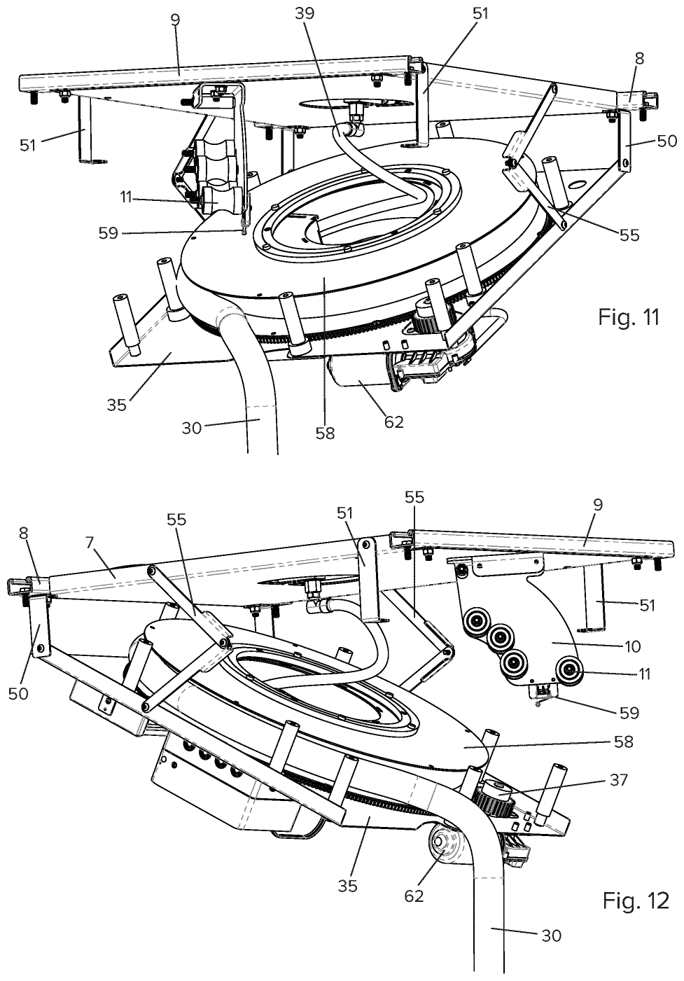

FIG. 11 is an isometric view from below showing how working components of the unit may be lowered for maintenance;

FIG. 12 is an isometric view from below as in FIG. 11 but from the other side;

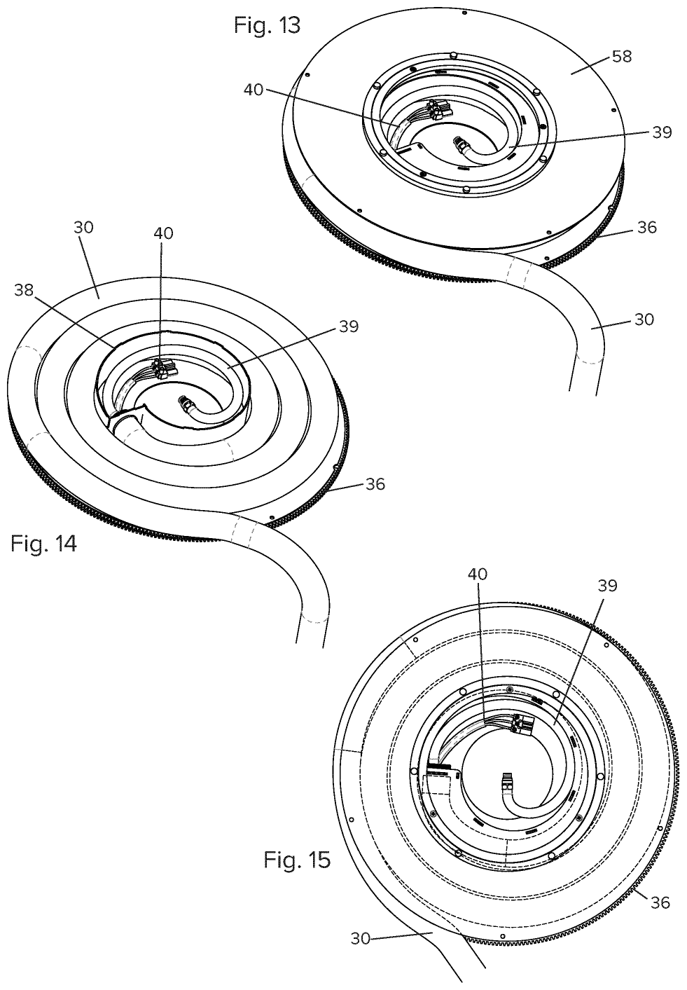

FIG. 13 is an isometric view from above showing a reel on to which the flexible conduit may be wound;

FIG. 14 is an isometric view from above of the reel shown in FIG. 13 but with its upper portion removed;

FIG. 15 is a view of the reel and flexible conduit seen from directly above;

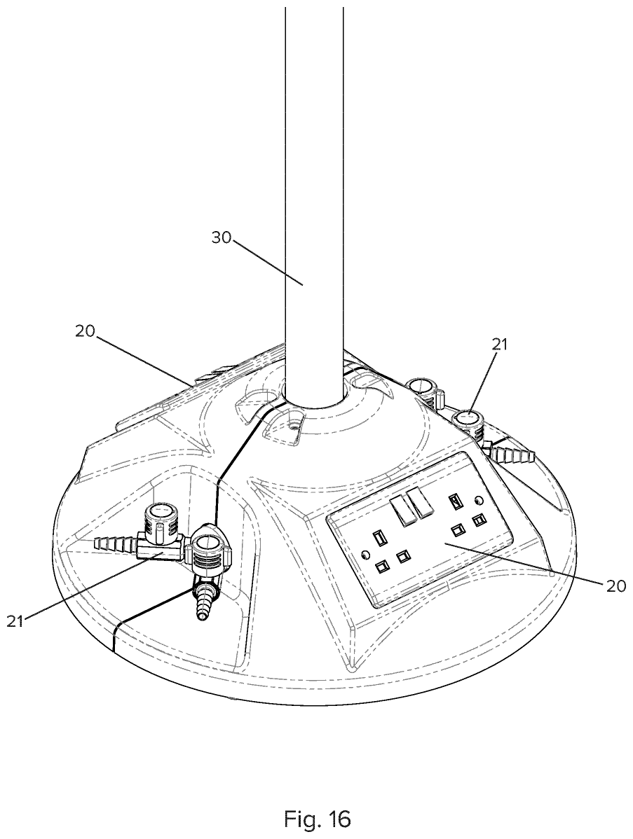

FIG. 16 is an isometric view from above showing the detailed appearance of the media supply head shown in FIG. 1;

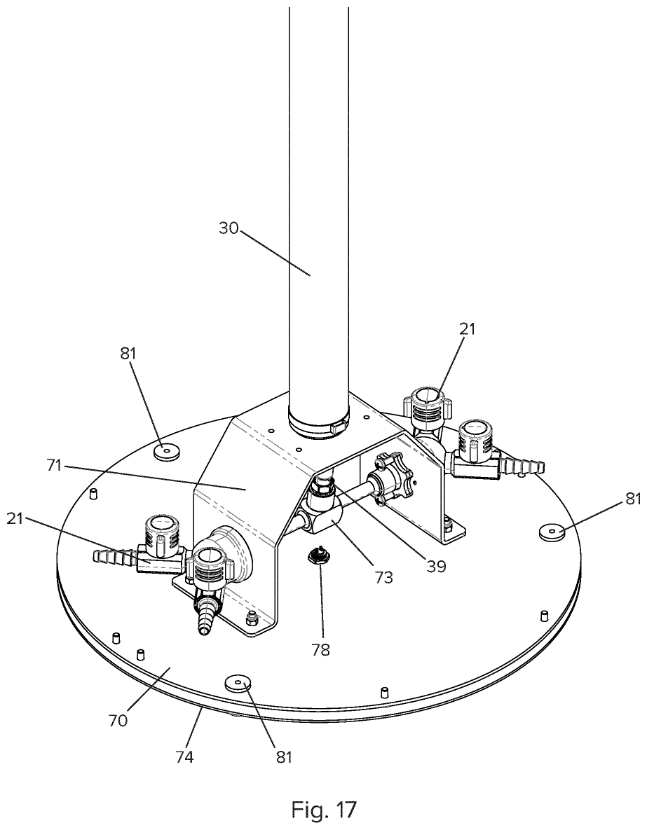

FIG. 17 is a isometric view from above of the underlying structure of the media supply head showing the basic mounting plate and support bracket together with certain components of a gas supply;

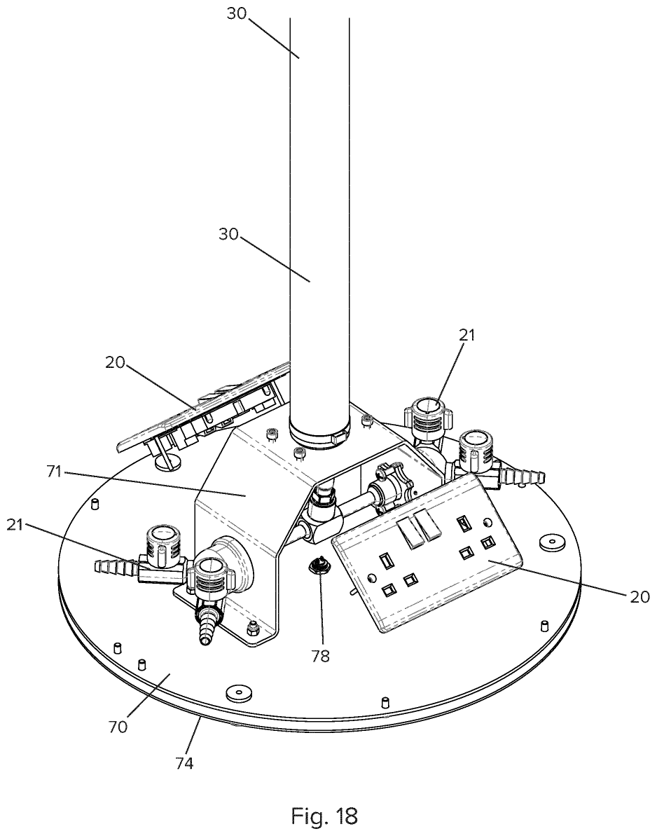

FIG. 18 is a view similar to FIG. 17 but showing the location of electrical outlets;

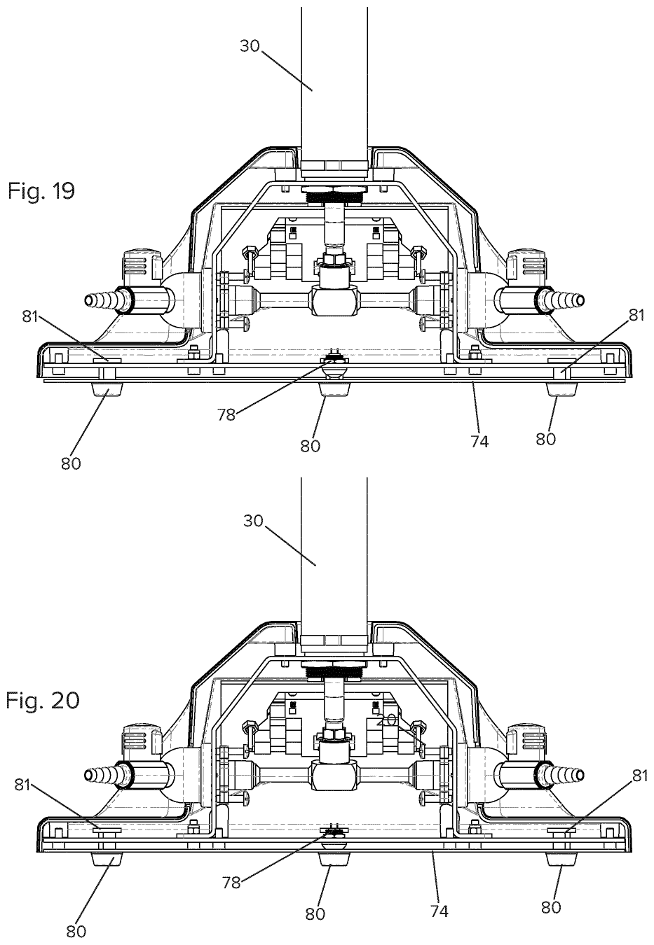

FIG. 19 is a cross sectional view of the media supply head as it is being lowered;

FIG. 20 is a cross sectional view similar to that of FIG. 19 but showing the media supply head when it is resting on a table or work bench surface or has been contacted by an obstacle during its descent;

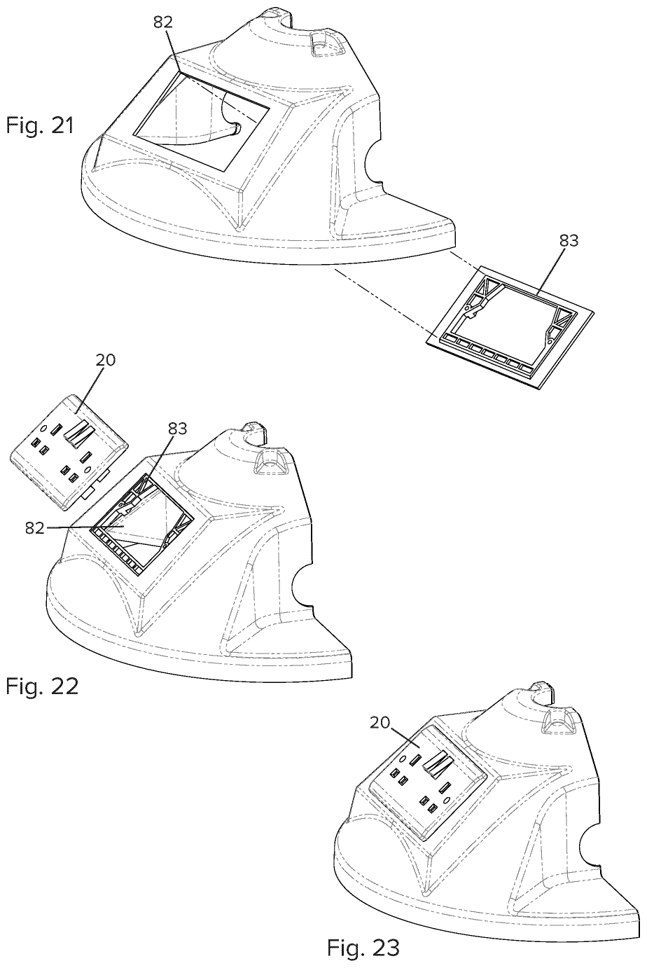

FIG. 21 is an isometric view of a half-shell cover portion for the media supply head and showing an adapter plate for fitting therein;

FIG. 22 is a view showing the components shown in FIG. 21 assembled to receive an electrical outlet; and

FIG. 23 shows the half-shell cover with the electrical outlet located in it.

Referring to the drawings the unit consists basically of a ceiling mounted operational unit 1, a lowerable media supply head 2 and a casing 3 which accommodates both when the media supply head is in its uppermost position. The operational unit 1 has a mounting base plate 7 and at each end of plate 7 a rail 8, 9 which enables the unit to be fixed to the ceiling structure in the building in which the unit is to be installed. Fixed to the base plate 7 is a guide bracket 10 having four rollers 11 which serve to guide a flexible conduit 30 between a spool on to which it can be wound located in the ceiling mounted unit and the media supply head 2. FIG. 1 shows a twin electrical socket outlet 20 and a twin gas tap outlet 21 on the media supply head 2.

The floor of casing 3 has a circular aperture 24 in it shown in FIG. 3 and as can be seen from FIG. 2 when fully retracted the media supply head 2 is flush with the floor of the casing 3. Casing 3 may be held by flanges 25 on two sides which have slots in them enabling the casing 3 to be bolted onto the ends of rails 8 and 9.

FIG. 3 shows the arrangement as the media supply head 2 is being lowered, suspended on the support cable located within the flexible conduit 30.

FIG. 4, from which the housing 3 and base plate 7 and other components have been omitted for the sake of clarity, is an isometric view of the principal operating components of unit 1 as the supply head 2 starts to be lowered, and FIG. 5 is a similar diagram but seen from directly above.

The principal components are mounted to either side of a mounting plate 35. Above plate 35, as can be seen in FIGS. 4 and 5, is located a spool for receipt of the flexible conduit 30, the lower circular side of the spool having a toothed edge 36, for engagement with a drive gear 37 and the spool having a central hub 38 around which the flexible conduit 30 is wound in the form of a spiral. As shown in more detail in FIGS. 13 to 15, the inner end of the conduit 30 is fixed to a radial plate portion of the hub 38. Projecting from the end of conduit 30 within the hub are a gas supply pipe 39 and an electrical cable 40 terminating in a connector block. The end of the gas supply pipe 39 is connected to a rotary gas connector unit, the fixed portion of which denoted 41 is connected to an external gas supply pipe 42, these being mounted on the base plate 7. The hub is connected to a circular top plate 58, spaced from the lower side of the spool by a distance slightly greater than the outside diameter of flexible conduit 30.

Also visible above mounting plate 35 are a number of support pillars 45 which maintain the mounting plate 35 parallel to and spaced from the base plate 7, as well as four suspension plates 50 and 51. Suspension plates 50 are fixed to the underside of rail 8 and mounting plate 35 is pivotally connected to them while plates 51 may be fixed to opposite edges of base plate 7 near rail 9. Also connected between base plate 7 and mounting plate 35 are two hinged linkages 55 which enable mounting plate 35 to be swung down by a defined amount for maintenance purposes.

This is shown in FIGS. 11 and 12 half way between the usual operational position shown in FIGS. 1 and 4 to 9 and the fully lowered position in which the hinged linkages 55 are fully extended. Before the mounting plate 35 is lowered, housing 3 is detached and the flexible conduit 30 extracted sideways from bracket 10, one side of which may be dismounted as shown in FIG. 10. The mounting plate 35 is then swung down to enable access to the centre of the hub so that the electrical connector on cable 40 may be disconnected and the pipe 39 detached from the fixed part 41 of the rotary gas connector.

Once that is done, the entire spool can be removed together with the flexible conduit and the media supply head 2, and any necessary maintenance or repair work carried out. Reassembly is done by reversing the procedure, taking care to ensure that the mounting plate 35 is properly repositioned and fixed via plates 51.

Located on the underside of mounting plate 35 are an electrical supply inlet box 60, a drive control unit 61, a drive motor unit 62 (with an output shaft connected to drive cog 37) and a rotary electrical connector 65 which enables the electrical supply to be fed from the electrical supply box 60 to the cable 40 located within hub 38.

The flexible conduit 30 which is wound on to or from the spool is fed through the guide bracket 10 over rollers 11 and terminates in the supply head 2.

When it is desired to lower that supply head, support plate 36 is driven in anti-clockwise sense as seen in FIG. 4 and the weight of the media supply head 2 keeps the flexible conduit 30 below bracket 10 vertical.

When it is desired to raise the media supply head 2 back up to its stowed position flush with the bottom of housing 3, the direction of drive of drive cog 37 is reversed and the flexible conduit is then wound up again on to the spool. A microswitch 59 mounted on the bottom of bracket 10 enables the drive control unit to stop the drive motor unit 62 when the media supply head arrives at its stowed position as shown in FIG. 2.

As can be seen in FIG. 16 onwards, the media supply head itself consists of a floor plate 70 to which is fixed a support bracket 71 and the base of flexible conduit 30 is secured to the horizontal upper portion of bracket 71. FIG. 17 shows the gas distribution system with a T-piece 73 connected to the lower end of pipe 39, the two outlet portions of T-piece 73 being connected to the standard dual outlet gas tap arrangements 21.

FIG. 18 shows relative to the components illustrated in FIG. 17 the positioning of two mains supply twin outlet sockets 20.

As shown in FIGS. 17 to 20, below floor plate 70 is located a floating plate 74 having three feet 80 each of which is mounted on a headed stud 81, and which, when the media supply head is not resting on a flat surface, is in the position shown in FIG. 19. When the media supply head 2 comes to rest on a flat surface, or encounters an object below it as it is being lowered, floating plate 74 moves slightly closer to base plate 70 as shown in FIG. 20 and this triggers a micro switch 78 which allows the drive control to detect that the supply head 2 is now resting as desired or has encountered an obstruction and to stop drive motor 62 from rotating the toothed edge 36 of the lower side of the spool any further.

The outer cover portion of supply head 2, indicated in dashed lines in FIG. 1, consists of two half-shells as illustrated in FIGS. 21 to 23. Each has a rectangular aperture 82 into which may be fitted an adapter plate 83 the external parts of which fit into the rectangular opening 82 while the diagrammatically indicated portions of plate 83 are arranged to receive the appropriate outlet, shown in the FIG. 22 as one of the dual outlet electrical sockets 20. FIG. 23 shows the arrangement when the socket 20 has been latched into and fixed to the adapter plate 83.

The drawings do not show the inextensible support cable, for example a twisted wire steel cable which is connected to bracket 71 at its lower end and to hub 38 at its upper end. This ensures that despite the flexibility of conduit 30, it essentially maintains its length because of the steel cable connecting the hub with the bracket.

Also not illustrated in the drawings are other media supplies which may be routed through conduit 30, for example electrical signal wiring, compressed air, suction or water.

1. A media supply unit comprising a base unit adapted to be mounted on or in a ceiling structure, a media outlet supply head connected to the base unit via a flexible support member, a spool located in the base unit and means for winding part of the flexible support member on to the spool or paying it out from the spool respectively to raise or lower the media outlet supply head relative to the base unit, and characterised in the flexible support member is a hollow flexible non-stretchable conduit and that one or more media supply pipes or cables extends from the base unit via the conduit to the media outlet supply head.

2. A media supply unit according to claim 1 wherein the spool has a hollow hub through which a media supply pipe passes between the flexible conduit and a rotary connector fixed to the base unit.

3. A media supply unit according to claim 1 or 2 wherein the spool has a hollow hub through which an electrical cable passes between the flexible conduit and a rotary connector fixed to the base unit.

4. A media supply unit according to any one of claims 1 to 3 wherein the base unit includes an electrically driven motor unit having an output shaft with a drive cog on it, and the edge of the spool has a toothed gear engaged with the drive cog, and means to drive the cog in either direction in order to lower or raise the media supply head accordingly.

5. A media supply unit according to any one of claims 1 to 4 and including means to detect when the media outlet supply head is resting on a desk or table.

6. A media supply unit according to claim 5 wherein the media outlet supply head includes a pressure-actuated or proximity-actuated switch in its base.

7. A media supply unit according to claim 5 wherein the base of the media outlet unit includes a first floor member fixed to the flexible conduit and a second floor member connected to the first by way of a lost motion connection, and including a microswitch fixed to the first floor member and arranged to be actuated when the two floor members approach one another as the media supply unit is brought to rest on a horizontal surface or encounters an obstruction.

8. A media supply unit according to claim 5 and including electrical load sensing means associated with a motor controller to detect when the moving media outlet supply head encounters an obstruction or reaches the end of its travel.

9. A media supply unit according to any one of the preceding claims and including valve and/or switch means within the base unit, or elsewhere in the media supply arrangements, arranged to cut off the supply of at least one medium to the media outlet supply head when it is lowered from the base unit but supported only by the flexible support member.

10. A media supply unit according to any one of the preceding claims wherein the media outlet head, the flexible conduit and the spool can be removed as a unit from the base unit following disconnection of any pipe(s) and/or cable(s) between the spool and the base unit.
